(19) United States
(12) Patent Application Publication
(10) Pub. No.: US 2026/0208140 A1
(43) Pub. Date: Jul. 23, 2026

(54) REACTOR WITH BACKFLOW SAFEGUARD

(71) Applicant: BASF SE, Ludwigshafen am Rhein (DE)

(72) Inventors: Frank HUETTEN, Ludwigshafen am Rhein (DE); Hans-Ruediger REEH, Einselthum (DE)

(21) Appl. No.: 19/138,707

(22) PCT Filed: Dec. 5, 2023
(86) PCT No.: PCT/EP2023/084227

§ 371 Date: Jun. 13, 2025

(30) Foreign Application Priority Data
Dec. 14, 2022 (EP) 22213335.7

(51) Int. Cl. B01J 19/00

(52) U.S. Cl. CPC B01J 19/002; B01J 2219/00164; B01J 2219/0027; B01J 2219/00389

(57) ABSTRACT

The invention relates to a reactor system comprising a reactor (1), a reactant conduit (2) for feeding a feedstock into the reactor (1) and a product conduit (9) for discharging an at least partly liquid reaction product from the reactor (1), wherein the reactant conduit (2) has a deflection (10) which leads from the inlet (3) of the feedstock into the reactant conduit upward to an apex (11) of the deflection (10) and from the apex (11) downward to the outlet opening (4) of the reactant conduit into the reactor (1), and the reactant conduit (2) has a closable ventilation opening (12), which is at a higher level with respect to the Earth's gravitational field than the inlet (3) of the feedstock into the reactant conduit and higher than the highest possible liquid level of the liquid reaction product in the reactor system.

The invention relates to a reactor system comprising a reactor, a reactant conduit for feeding a feedstock into the reactor and a product conduit for discharging a liquid reaction product from the reactor. The invention further relates to a method of safeguarding a reactor system.

Chemical reactions are typically conducted in closed apparatuses, which are also referred to hereinafter as “reactors”. For safety reasons, it has to be ensured that the chemical reaction takes place exclusively in the apparatuses intended for the purpose and does not continue uncontrolled in apparatuses other than those intended for the purpose. It is frequently the case that the feedstocks intended for the reaction are fed to the reactor through pipelines from storage tanks or other vessels. Particularly in applications in which the feedstocks can react with one another on contact, it has to be ensured that the feedstocks or the reaction mixture in the reactor do not/does not flow back out of the reactor into the storage tanks or vessels, in order to avoid an uncontrolled reaction in these vessels. For example, backflow can be caused by rising pressure in the reactor as the reaction proceeds, and portions of the reactor contents are pushed back through the pipelines or the pump for conveying the feedstock is switched off.

The prior art discloses what are called backflow safeguards, which are intended to prevent un-wanted backflow from the reactor into upstream vessels. For example, it is known to provide that at least one stop valve can be provided in the conduit through which a feedstock flows to the reactor, which is configured in such a way that it closes automatically after detection of a backflow.

Document EP 3 417 935 A1 discloses a system and a method for controlling a chemical reaction, in which the reaction in a reactor is monitored and the following measures are taken to prevent an uncontrolled reaction: blocking of the inlet to and the outlet from the reactor, active de-pressurization of the reactor and purging of the reactor with an inert substance.

Document DE 10 2020 126 882 A1 discloses a device for monitoring deflagration or thermal detonation in a continuously operated chemical tube reactor, with the aim of preventing the spread of a heat front. The device has at least one barrier for blocking the inlet and/or outlet, the barrier comprising at least a valve and a body. The body is designed to stop a heat front of deflagration or thermal detonation before the valve is closed.

Such safeguarding is adequate for some types of reaction systems. However, a disadvantage of this is that, because of leaks in the stop valve or because the stop valve closes too slowly, a small but possibly nevertheless undesirable or even dangerous backflow can take place. In addition, in the event of a failure or fault in the stop valve, there is a risk that significant amounts of reactor product will flow back into the feeds and connected vessels.

In order to remedy the problems mentioned, backflow safeguards are known, which provide at least two stop valves connected in series. In addition to the redundancy that becomes relevant in the event of a failure or a fault in one of the stop valves, these systems also provide some degree of protection against leakage. If, for example, because of a rapid increase in pressure, the stop valve disposed closest to the reactor does not close quickly enough, the amount of back-flowing reactor contents still flowing through this stop valve may possibly be trapped in the pipeline section between the two stop valves if the stop valve further away from the reactor closes sufficiently quickly. In such devices, it may be the case that the pipeline section between the stop valves is provided with a drain device, by means of which any trapped reactor product can be disposed of safely. Although this type of backflow safeguard already constitutes an advantage over simple systems described above, it does not offer complete protection against possible backflow, especially in the case of an abrupt occurrence of backflow, for example owing to a rapid increase in pressure in the reactor.

The object was to further develop known reactor systems with backflow safeguards in such a way that a potential backflow of reactor contents from the reactor into upstream vessels such as storage tanks or other process engineering apparatus is reliably prevented.

This object is achieved in accordance with the invention by a reactor system according to claim 1 and a method of safeguarding the reactor system according to claims 8 and 9. Advantageous configurations of the reactor system are specified in claims 2 to 7.

The invention firstly provides a reactor system comprising a reactor, a reactant conduit for feeding a feedstock into the reactor and a product conduit for discharging an at least partly liquid reaction product from the reactor. The reactant conduit has a deflection leading from the inlet of the feedstock into the reactant conduit upward to an apex of the deflection and from the apex downward to the outlet opening of the reactant conduit into the reactor.

The reactant conduit also has a closable ventilation opening which is at a higher level with respect to the Earth's gravitational field than the inlet of the feedstock into the reactant conduit and higher than the highest possible liquid level of the liquid reaction product in the reactor system.

The invention further provides a method of safeguarding a reactor system comprising a reactor, a reactant conduit for feeding a feedstock into the reactor and a product conduit for discharging an at least partly liquid reaction product from the reactor, wherein the reactant conduit has a deflection which leads from the inlet of the feedstock into the reactant conduit upward to an apex of the deflection and from the apex downward to the outlet opening of the reactant conduit into the reactor, and the reactant conduit has a closable ventilation opening, which is at a higher level with respect to the Earth's gravitational field than the inlet of the feedstock into the reactant conduit and higher than the highest possible liquid level of the liquid reaction product in the reactor system. The method comprises the steps of metrological determination of a signal characteristic of the flow of the feedstock in the reactant conduit, and the opening of the ventilation opening when the characteristic signal infringes a preset limit.

The reactor system of the invention and the method of the invention have the advantage that a gas bubble can be generated by means of the ventilation opening in the reactant conduit, which reliably prevents both flow of the feedstock in the direction of the reactor and backflow of portions of the reactor contents in the direction of the reactant conduit. Because the gas bubble that forms after opening of the ventilation opening is at a point in the reactant conduit at a higher level than the inlet of the feedstock into the reactant conduit and higher than the highest possible liquid level of the liquid reaction product in the reactor system, the gas bubble in the reactant conduit constitutes an insurmountable barrier to potential backflow from the reactor into the reactant conduit. Another advantage of the reactor system of the invention is that the backflow safeguarding can be implemented in a simple manner with robust and proven components that additionally require little maintenance.

The words “up”, “upward”, “down”, “downward” and similar directional or positional statements should be understood in relation to the Earth's gravitational field. A first component disposed “above” a second component is thus at a greater distance from the Earth's surface than the second component. Accordingly, the “apex” is the highest point in the deflection in the reactant conduit in relation to the Earth's gravitational field.

The reactor system comprises at least one reactor. The reactor system may also comprise two or more reactors arranged for flow purposes in series, in parallel, or partly in series and partly in parallel. The reactor system may comprise further constituents, for example devices typical of chemical engineering plants, such as pumps, pipelines, vessels, tanks, heat exchangers or separation devices such as phase separators, extraction columns, rectification columns or other separation apparatuses.

The at least one reactor is a vessel which is closed to the environment and in which a chemical reaction can take place. The reactor may have any known shape and function and be designed as a single apparatus or reaction zone integrated into another apparatus, for example as a stirred tank reactor, tubular reactor or reactive distillation column.

The reactor system of the invention is not limited with regard to the chemical reactions that proceed therein. For example, the reaction that proceeds in the reactor may proceed spontaneously through contacting of the feedstocks or may be started by a catalyst. The catalyst here may be homogeneous or heterogeneous. The reaction system may be intended for any mode of performance of the reaction, for example for batchwise mode, semibatchwise mode or continuous mode.

The reactor system is intended to supply at least one feedstock to the reactor. Two or more feedstocks can also be supplied to the reactor system. In the case of two or more feedstocks, these may be fed to the reactor together via one reactant conduit or separately via separate reactant conduits. In addition, a catalyst that promotes or initiates the reaction of the feedstock in the reactor can also be supplied to the reactor.

The reactant conduit for supplying the at least one feedstock and the product conduit for discharging the reaction product may be designed in a known manner, for example as pipelines connecting the reactor to a tank or other vessels or chemical engineering apparatus. Further components such as pumps, heat exchangers, control valves, measuring devices or stop valves may be disposed in the reactant conduit or the product conduit.

The reaction product that results from the reaction of the feedstock supplied to the reactor is at least partly liquid. The reaction product may be completely liquid. It may also contain proportions of steam or gas, either as separate phases or dissolved in the liquid. The reaction product may also include one or more liquid phases and a vapor phase or gas phase. Depending on the type of feedstocks used and the chemical reaction that proceeds, solids may also be present in the reaction product, for example in the case of precipitation or crystallization.

According to the invention, the closable ventilation opening is at a higher level with respect to the Earth's gravitational field than the highest possible liquid level of the liquid reaction product in the reactor system. The highest possible liquid level is influenced firstly by the structural and geometric features of the reactor system and secondly by the procedure conducted in the reactor system. The highest possible liquid level corresponds to the maximum liquid level that the liquid reaction product in the reactor system can reach. This may be a fluid level that is reached in the regular course of the process conducted. It may also be a liquid level that is reached only in exceptional situations, for example during an unplanned pressure increase in the reactor system.

The highest possible liquid level can be established in the reactor or in a vessel or apparatus connected to the reactor. Examples of connected apparatuses or vessels are heat exchangers such as condensers, phase separators, separation devices such as columns, pressure reducers such as expansion valves, storage tanks, and pipelines connecting the apparatuses and/or vessels.

In one embodiment of the reactor system of the invention, a stop valve is disposed in the reactant conduit upstream of the deflection in flow direction of the feedstock. The presence of a stop valve in the reactant conduit has the advantage of additional protection against backflow. In addition, it can be ensured that no further reactant is conveyed in the direction of the reactor. The stop valve is preferably provided with a drive which can be controlled via electronic signals. The stop valve is preferably a controllable ball valve or a control valve. In one modification of this embodiment, at least two stop valves are arranged in series in the reactant conduit upstream of the deflection in flow direction of the feedstock.

According to the invention, the ventilation opening in the reactant conduit is both at a higher level than the inlet of the feedstock into the reactant conduit and at a higher level than the highest possible liquid level of the liquid reaction product in the reactor system. The ventilation opening may therefore be located in different places in the reactant conduit. In one embodiment, the ventilation opening is disposed at the apex of the deflection.

The ventilation opening can be implemented in different ways. The ventilation opening is preferably configured such that, when the ventilation opening is opened, no potentially harmful substance, for example gaseous components of a feedstock or from the inside of the reactor, can pass through the ventilation opening into the environment. In one embodiment of the reactor system of the invention, a ventilation conduit for supply of a gas to the reactant conduit is connected to the ventilation opening, where the ventilation conduit has a stop valve. For example, an inert gas which is inert with respect to the feedstock present in the reactant conduit can be introduced into the reactant conduit through the ventilation conduit in order to form a gas bubble which prevents backflow. A particularly suitable inert gas is nitrogen. Depending on the properties of the feedstock, other substances may also be suitable as inert gas.

In an advantageous development, the reactor system further comprises a vessel into which the product conduit for discharging the liquid reaction product from the reactor opens, the vessel is set up to accommodate a gas volume and a liquid volume, the liquid volume is provided with at least one outlet for liquid reaction product, and the gas volume has at least one outlet into a conduit which is connected to the ventilation opening in a closable manner. In this embodiment of the reactor system, it is advantageously possible to implement a self-contained system in that the gas volume from the vessel can be introduced into the reactant conduit if necessary through the ventilation opening in the deflection in order to form a gas bubble therein, which prevents backflow.

The gas volume in the vessel may be gas that is formed in the reactor during the reaction of the feedstock and flows from the reactor into the vessel. However, there may also be a further connection of a gas conduit to the vessel, through which gas can be introduced into the vessel in a controlled manner. This variant is advantageous, for example, if an inert gas, e.g. nitrogen, is to be provided as the gas volume in the vessel.

In an advantageous development, the reactor system further comprises a sensor system and a safety circuit with a comparison unit and output means, where the sensor system is set up to determine a signal characteristic of the flow of the feedstock in the reactant conduit, the comparison unit is set up to compare the signal with a preset limit, and if the limit is infringed by the signal, the output means cause the stop valve in the reactant conduit to close and the ventilation opening to open. By means of the sensor system and the safety circuit, fully automatic monitoring of the reactor system can be implemented.

The sensor system may include sensors known in the prior art for different state variables in the chemical engineering process, for example sensors for detecting pressure, temperature, flow rate, density. Signals characteristic of the flow of the feedstock in the reactant conduit are considered to be all signals that allow a conclusion as to the flow in the reactant conduit. In one embodiment of the invention, the signal characteristic of the flow of the feedstock in the reactant conduit is a quantitative measurement of the flowing feedstock, a differential pressure measurement, or both a quantitative measurement and a differential pressure measurement. One advantage of these signals is that there is sufficiently established technology to provide the signals reliably and with low maintenance. A further advantage is that a limit can be set in a simple and intuitive manner for this type of signals, against which the values ascertained from the sensors can be compared.

The safety circuit comprises a comparison unit which is set up to compare the sensor signal with a preset limit. The comparison can be conducted in any suitable computation unit, for example in the computation unit of a microcontroller, which is implemented in a safety-oriented controller, a programmable controller or in a process control system (PCS). The safety circuit can be implemented in the form of software components, hardware components, or combinations of hardware and software components. The sensor signals can be read in via any means of communication via which data signals can be transmitted from a measuring device to a data processing device. These may be wired means of communication, wireless means of communication, or combinations of these. The selection of the respective means is guided by the requirements of the application.

The limit in the comparison unit can be defined in different ways. In one embodiment, the limit is entered manually via an operating unit, for example a keyboard, an operating panel, a writable display or a microphone for entering voice commands. This embodiment is especially suitable for applications in which backflow safeguarding is provided as a stand-alone application. In a further embodiment, the limit in the comparison unit is transmitted via a communication inter-face. This embodiment is especially suitable for applications in which the backflow safeguard is part of a more comprehensive automation system or monitoring system, for example, when the backflow safeguard is integrated into a process control system.

The output means of the safety circuit are suitable for causing the stop valve in the reactant conduit to close and the ventilation opening to open. In one embodiment, the output means are signals that are sent via communication interfaces to the stop valve and the ventilation opening. In this case, the stop valve and the ventilation opening are correspondingly configured to receive the signals. The signals can be transmitted via wired means of communication, wireless means of communication or combinations thereof. The selection of the respective means is guided by the requirements of the application.

The invention further provides a method of safeguarding a reactor system comprising a reactor, a reactant conduit for feeding a feedstock into the reactor and a product conduit for discharging an at least partly liquid reaction product from the reactor, where the reactant conduit has a deflection which leads from the inlet of the feedstock into the reactant conduit upward to an apex of the deflection and from the apex downward to the outlet opening of the reactant conduit into the reactor, and the reactant conduit has a closable ventilation opening, which is at a higher level with respect to the Earth's gravitational field than the inlet of the feedstock into the reactant conduit and higher than the highest possible liquid level of the liquid reaction product in the reactor system, a stop valve is disposed in the reactant conduit upstream of the deflection in flow direction of the feedstock, and the reactor system further comprises a sensor system and a safety circuit with a comparison unit and output means, wherein the method comprises the following steps:
a) determining a signal characteristic of the flow of the feedstock in the reactant conduit in the sensor system,
b) comparing the characteristic signal with a preset limit in the comparison unit, and
c) in the event of infringement of the limit by the characteristic signal, outputting output signals using the output means that cause closure of the stop valve in the reactant conduit and opening of the ventilation opening.

The invention further provides for the use of a reactor system of the invention in processes in which feedstocks are converted to products in a chemical reaction, where at least one feedstock is selected from the group of aldehydes, alcohols, epoxides, amines and organic acids, and/or where the chemical reaction is selected from the group of enalizations, ethoxylations, amidations and esterifications.

The invention will be elucidated in detail hereinafter with reference to the drawings. The drawings should be considered to be schematic diagrams. They do not constitute a restriction of the invention, for example with regard to specific dimensions or configuration variants, unless the description of the drawings indicates otherwise. The figures show:

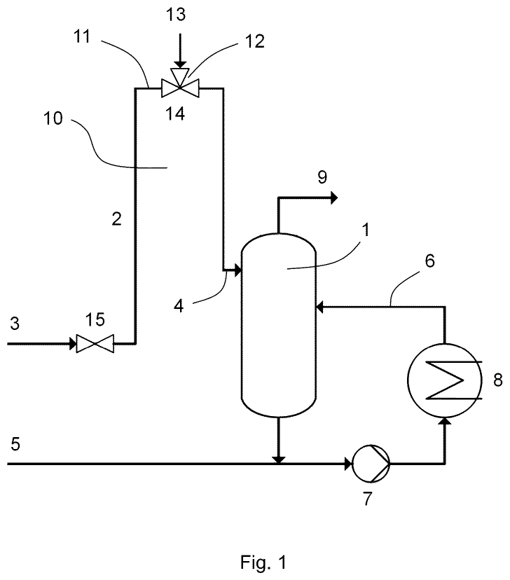

FIG. 1: flow diagram of a first embodiment of a reactor system of the invention

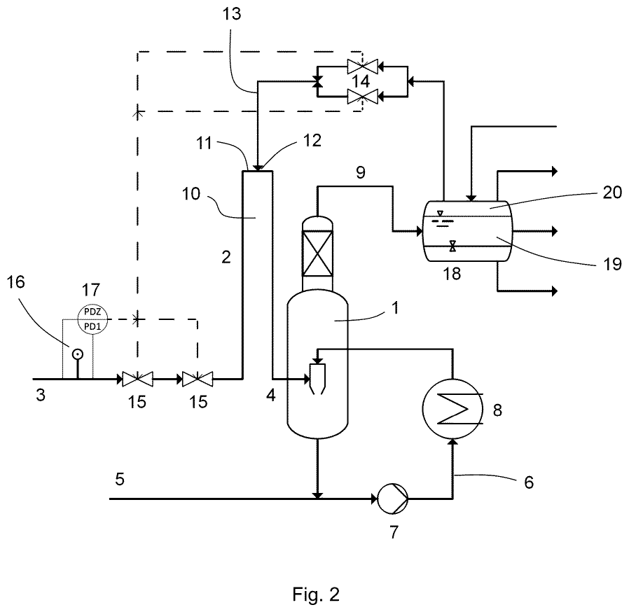

FIG. 2: flow diagram of a second embodiment of a reactor system of the invention

### LIST OF REFERENCE NUMERALS USED

1 . . . reactor
2 . . . reactant conduit
5 . . . further reactant conduit
6 . . . circulation system
7 . . . pump
8 . . . heat exchanger
9 . . . product conduit
10 . . . deflection
11 . . . apex of the deflection
12 . . . ventilation opening
13 . . . ventilation conduit
14 . . . stop valve
15 . . . stop valve
16 . . . measurement orifice
17 . . . differential pressure controller
18 . . . vessel
19 . . . liquid volume
20 . . . gas volume

FIG. 1 shows a schematic of a flow diagram of a first embodiment of a reactor system of the invention. The reactor system comprises a reactor 1 in which a feedstock (reactant) is converted to a product by contacting with a further substance in a chemical reaction. The further substance may, for example, be a further feedstock (further reactant) or a catalyst. The chemical reaction takes place at least partly in the liquid phase, and the product of the reaction is at least partly liquid. The feedstock to be converted is fed to the reactor 1 via a reactant conduit 2, for example from a storage tank (not shown). The further feedstock or catalyst is fed to the reactor 1 via a further reactant conduit 5, for example from a further storage tank (likewise not shown). In the example shown, the reactor 1 has a circulation system 6 in which a portion of the liquid reactor contents is drawn off at the bottom of the reactor, fed via a pump 7 to a heat exchanger 8 and returned back to the reactor 1 after exiting from the heat exchanger. Depending on the type of reaction to be conducted, heat can be supplied to the reaction mixture in a suitable manner via the circulation system 6 via the heat exchanger 8, or heat can be removed from the reaction mixture. In the example shown, the further reactant conduit 5 opens into the circulation conduit between exit from the reactor and entry into the pump 7. However, the further feedstock or catalyst can also be fed into the circulation system 6 elsewhere or directly into the reactor 1. At the top of the reactor 1, the at least partly liquid reaction product is withdrawn through a product conduit 9.

The reactant conduit 2 has a deflection 10 leading from the inlet 3 of the feedstock into the reactant conduit upward to an apex 11 of the deflection and from the apex 11 downward to the outlet opening 4 of the reactant conduit into the reactor 1. In the example shown, the inlet 3 of the reactant conduit is at a lower level than the outlet 4 of the reactant conduit with respect to the Earth's gravitational field. However, inlet 3 and outlet may also be at the same height, or the inlet 3 may be at a higher level than the outlet 4.

The reactant conduit 2 has a closable ventilation opening 12 which is at a higher level with respect to the Earth's gravitational field than the inlet 3 of the feedstock into the reactant conduit 2 and higher than the highest possible liquid level of the liquid reaction product in the reactor system. In the example shown, the product conduit 9 that leads away from the top of the reactor 1 constitutes the highest possible liquid level of the liquid reaction product in this reactor system. In this example, the ventilation opening 12 is designed as a stop valve 14 in the form of a three-way valve into which a ventilation conduit 13 opens. The stop valve 14 is disposed at the apex 11 of the deflection 10 and is above the product offtake 9. In flow direction of the feedstock, a further stop valve 15 is disposed in the reactant conduit 2 upstream of the deflection 10.

The reactor system according to FIG. 1 is reliably safeguarded against possible backflow of the liquid reactor contents in the direction of the reactant conduit 2. Should backflow occur, caused for example by an increase in pressure in reactor 1, the stop valve 15 in the reactant conduit 2 is firstly closed. In addition, the stop valve 14 in the deflection 10 is switched such that a gas, for example an inert gas such as nitrogen, is introduced into the ventilation opening 12 of the deflection 10 through the ventilation conduit 13. Since the ventilation opening 12 is above all possibly liquid-carrying constituents of the reactor system, the gas volume present in the ventilation opening 12 of the reactant conduit 2 constitutes an insurmountable barrier to possible liquid backflow, and so, even in the event of a leakage of the stop valve 15 in the reactant conduit 2, no liquid from the reactor 1 can reach the stop valve 15.

FIG. 2 shows a schematic of a flow diagram of a second embodiment of a reactor system of the invention. The basic configuration of the reactor including the reactant feeds and the circulation system 6 through a heat exchanger 8 corresponds essentially to the reactor system described above in association with FIG. 1. The reactor 1 has a nozzle into which the outlet 4 from the reactant conduit 2 opens. The circulation system 6, which is returned to reactor 1, likewise opens into the nozzle and ensures vigorous mixing of the reactor contents with the feedstock supplied during operation. The product formed in reactor 1 is drawn off via a product conduit 9 at the top of reactor 1 and fed to a vessel 18 in which the reaction product can physically separate. In the vessel 18 shown in this example, which is also referred to as “phase separator”, the reaction product is separated into a gas phase and two different liquid phases. Depending on the com-position of the reaction product, this may, for example, be an organic phase and an aqueous phase. There is thus a gas volume 20 and a liquid volume 19 in the vessel 18. The phases or volumes may be drawn off independently from the vessel 18 through conduits. In this example, the gas volume 20 of the vessel 18 is connected to the ventilation conduit 13 via a conduit and two stop valves 14 that are arranged in parallel for flow purposes. Through a further conduit that opens into the gas phase of the vessel 18, an inert gas, for example, can be fed to the gas volume 20 in the vessel 18.

In the reactant conduit 2, in the example shown, two stop valves 15 are arranged in succession upstream of the deflection 10 in flow direction of the feedstock. A measurement orifice 16 is mounted between the inlet 3 in the reactant conduit and the first stop valve 15. Pressure sensors (not shown) are used to determine signals for the pressure upstream and downstream of the measurement orifice 16, viewed in flow direction. The two sensor signals are used, in a differential pressure controller 17, to calculate a value for the determined differential pressure. A limit for the permissible maximum differential pressure is preset in the differential pressure controller 17. As soon as the differential pressure calculated on the basis of the measured pressure signals exceeds the preset limit, the differential pressure controller 17 transmits output signals to the two stop valves 15 in the reactant conduit 2 and to the two stop valves 14 in the ventilation conduit 13. The output signals cause the two stop valves 15 in the reactant conduit 2 to close and the two stop valves 14 in the ventilation conduit to open. This has the consequence that a portion of the gas volume 20 in the vessel 18 flows through the ventilation conduit 13 via the ventilation opening 12 at the apex 11 of the deflection 10 into the reactant conduit 2. Since the ventilation opening 12 is above all possibly liquid-carrying constituents of the reactor system, the gas volume present in the ventilation opening 12 of the reactant conduit 2 constitutes an insurmountable barrier to possible liquid backflow, and so, even in the event of a leakage of the stop valve 15 in the reactant conduit 2, no liquid from the reactor 1 can reach the stop valve 15.

In the example shown, a signal for a differential pressure upstream and downstream of the measurement orifice 16 provides a reliable value as an indicator of a possible backflow of a portion of the reactor contents into the reactant conduit. The differential pressure is a signal characteristic of the flow of the feedstock in the reactant conduit 2. However, other characteristic signals can also be used to detect possible backflow, for example a measurement of the amount of feedstocks flowing through the reactant conduit 2. Appropriate technical measuring instruments for determining the mass flow rate or volume flow rate are known and available in the prior art.

1.-10. (canceled)

11. A reactor system comprising a reactor (1), a reactant conduit (2) for feeding a feedstock into the reactor (1) and a product conduit (9) for discharging an at least partly liquid reaction product from the reactor (1), wherein the reactant conduit (2) has a deflection (10) leading from the inlet (3) of the feedstock into the reactant conduit upward to an apex (11) of the deflection (10) and from the apex (11) downward to the outlet opening (4) of the reactant conduit into the reactor (1), and the reactant conduit (2) has a closable ventilation opening (12) at a higher level with respect to the Earth's gravitational field than the inlet (3) of the feedstock into the reactant conduit and higher than the highest possible liquid level of the liquid reaction product in the reactor system.

12. The reactor system according to claim 11, wherein a stop valve (15) is disposed in the reactant conduit (2) upstream of the deflection (10) in flow direction of the feedstock.

13. The reactor system according to claim 11, wherein the ventilation opening (12) is disposed at the apex (11) of the deflection (10).

14. The reactor system according to claim 11, wherein a ventilation conduit (13) for supply of a gas to the reactant conduit (2) is connected to the ventilation opening (12), where the ventilation conduit (13) has a stop valve (14).

15. The reactor system according to claim 11, wherein the reactor system further comprises a vessel (18) into which the product conduit (9) for discharging the liquid reaction product from the reactor (1) opens, the vessel (18) is set up to accommodate a gas volume (20) and a liquid volume (19), the liquid volume (19) is provided with at least one outlet for liquid reaction product, and the gas volume (20) has at least one outlet into a conduit which is connected to the ventilation opening (12) in a closable manner.

16. The reactor system according to claim 12, wherein the reactor system further comprises a sensor system and a safety circuit with a comparison unit and output means, where the sensor system is set up to determine a signal characteristic of the flow of the feedstock in the reactant conduit (2), the comparison unit is set up to compare the signal with a preset limit, and if the limit is infringed by the signal, the output means cause the stop valve (15) in the reactant conduit (2) to close and the ventilation opening (12) to open.

17. The reactor system according to claim 16, wherein the signal characteristic of the flow of the feedstock in the reactant conduit (2) is a quantitative measurement of the flowing feedstock or a differential pressure measurement.

18. A method of safeguarding a reactor system comprising a reactor (1), a reactant conduit (2) for feeding a feedstock into the reactor (1) and a product conduit (9) for discharging an at least partly liquid reaction product from the reactor (1), where the reactant conduit (2) has a deflection (10) which leads from the inlet (3) of the feedstock into the reactant conduit upward to an apex (11) of the deflection (10) and from the apex (11) downward to the outlet opening (4) of the reactant conduit into the reactor (1), and the reactant conduit (2) has a closable ventilation opening (12), which is at a higher level with respect to the Earth's gravitational field than the inlet (3) of the feedstock into the reactant conduit and higher than the highest possible liquid level of the liquid reaction product in the reactor system, the method comprising the steps of metrological determination of a signal characteristic of the flow of the feedstock in the reactant conduit (2), and the opening of the ventilation opening (12) when the characteristic signal infringes a preset limit.

19. A method of safeguarding a reactor system comprising a reactor (1), a reactant conduit (2) for feeding a feedstock into the reactor (1) and a product conduit (9) for discharging an at least partly liquid reaction product from the reactor (1), where the reactant conduit (2) has a deflection (10) which leads from the inlet (3) of the feedstock into the reactant conduit upward to an apex (11) of the deflection (10) and from the apex (11) downward to the outlet opening (4) of the reactant conduit into the reactor (1), the reactant conduit (2) has a closable ventilation opening (12), which is at a higher level with respect to the Earth's gravitational field than the inlet (3) of the feedstock into the reactant conduit and higher than the highest possible liquid level of the liquid reaction product in the reactor system, a stop valve (15) is disposed in the reactant conduit (2) upstream of the deflection (10) in flow direction of the feedstock, and the reactor system further comprises a sensor system and a safety circuit with a comparison unit and output means, said method comprising the steps of:
a) determining a signal characteristic of the flow of the feedstock in the reactant conduit (2) in the sensor system,
b) comparing the characteristic signal with a preset limit in the comparison unit, and
c) in the event of infringement of the limit by the characteristic signal, outputting output signals using the output means that cause closure of the stop valve (15) in the reactant conduit (2) and opening of the ventilation opening (12).

20. A reactor system according to claim 11 for converting feedstocks to products in a chemical reaction, where at least one feedstock is selected from the group of aldehydes, alcohols, epoxides, amines and organic acids, or where the chemical reaction is selected from the group of enalizations, ethoxylations, amidations and esterifications.
